(19) United States
(12) Patent Application Publication
(10) Pub. No.: US 2007/0152371 A1
(43) Pub. Date: Jul. 5, 2007

(54) Closed corner mold for corner shaped simulated stone products

(76) Inventors: Michelle L. Korwin-Edson, Pataskala, OH (US); Robert E. Embrey, Newark, OH (US)

Correspondence Address: OWENS CORNING, 2790 COLUMBUS ROAD, GRANVILLE, OH, 43023, US

(21) Appl. No.: 11/323,618

(22) Filed: Dec. 30, 2005

(51) Int. Cl. B28B 3/00; B29C 33/58

(52) U.S. Cl. 264/316; 264/333; 425/383; 425/389

(57) ABSTRACT

A mold for manufacturing a simulated corner stone product includes a flexible layer that includes one or more corner stone shaped mold cavities. A cover is removably positioned against each mold cavity such that a back face of each corner stone product is formed with a desirable molded interior angle.

### TECHNICAL FIELD AND INDUSTRIAL APPLICABILITY OF THE INVENTION

The present invention relates to a mold useful for manufacturing simulated corner stone products.

### BACKGROUND OF THE INVENTION

Simulated stone products include simulated stone veneers and simulated stone architectural trim products. Simulated stone veneers are used as a lightweight veneer facing on masonry, and on metal framed or wood framed construction for architectural aesthetics. The products can be used for exterior applications such as building walls or interior applications such as fireplaces. Simulated stone architectural trim products include capstones, hearthstones, keystones, trim stones and the like. The simulated stone products are usually lower in cost than the natural stones that they replace. CULTURED STONE® products are simulated stone products manufactured by Cultured Stone Corporation, a division of Owens Corning, Napa, Calif. The CULTURED STONE® product line includes hundreds of designs of precast stone veneers and architectural trim products that replicate an extensive variety of textures, sizes, shapes and colors of natural stone. The products are manufactured using molds taken from natural stones. The molds generally include a mold cavity filled with a castable material. After the castable material has cured, or set, the simulated stone products are removed from the mold.

It is especially desired to have many types and shapes of simulated stone products. Corner stone products, however, are especially difficult and often expensive to make. Simulated corner stone product have a more complicated shape than flat stone products and have more surfaces that are visible when the corner stone product is installed. It is difficult to economically make a simulated stone corner product since the mold itself and the molding/unmolding labor costs greatly exceed those for flat stone products.

### SUMMARY OF THE INVENTION

A mold for manufacturing a simulated corner stone product has a flexible layer having a mold cavity in the shape of the simulated corner stone product to be formed. Each mold cavity has walls and a bottom configured to imprint a stone texture on side faces of the corner stone product. A cover is positioned against the mold cavity such that a back face of the corner stone product is formed with a desirable molded interior angle.

Various advantages of this invention will become apparent to those skilled in the art from the following detailed description of the preferred embodiments, when read in light of the accompanying drawings.

### BRIEF DESCRIPTION OF THE DRAWINGS

FIG. 1 is a perspective view, partially in phantom, of one embodiment of a mold for a corner stone product.

FIG. 1A is a schematic perspective view, partially in phantom, of a corner cavity section of the mold shown in FIG. 1.

FIG. 2 is a partial elevational view, partially in phantom, of the mold shown in FIG. 1 after a castable material has been introduced into mold cavities in the mold.

FIG. 3 is a view taken along the line 3-3 in FIG. 2.

FIG. 4A is a schematic perspective view, partially in phantom, of a corner simulated stone product, as viewed from its back face.

FIG. 4B is a schematic perspective view, partially in phantom, of a corner simulated stone product, as viewed from its back face.

FIG. 5 is a perspective view, partially in phantom, of another embodiment of a mold for a corner stone product.

FIG. 6 is a cross-sectional view of another embodiment of a mold for a corner stone product.

### DETAILED DESCRIPTION OF THE PREFERRED EMBODIMENTS

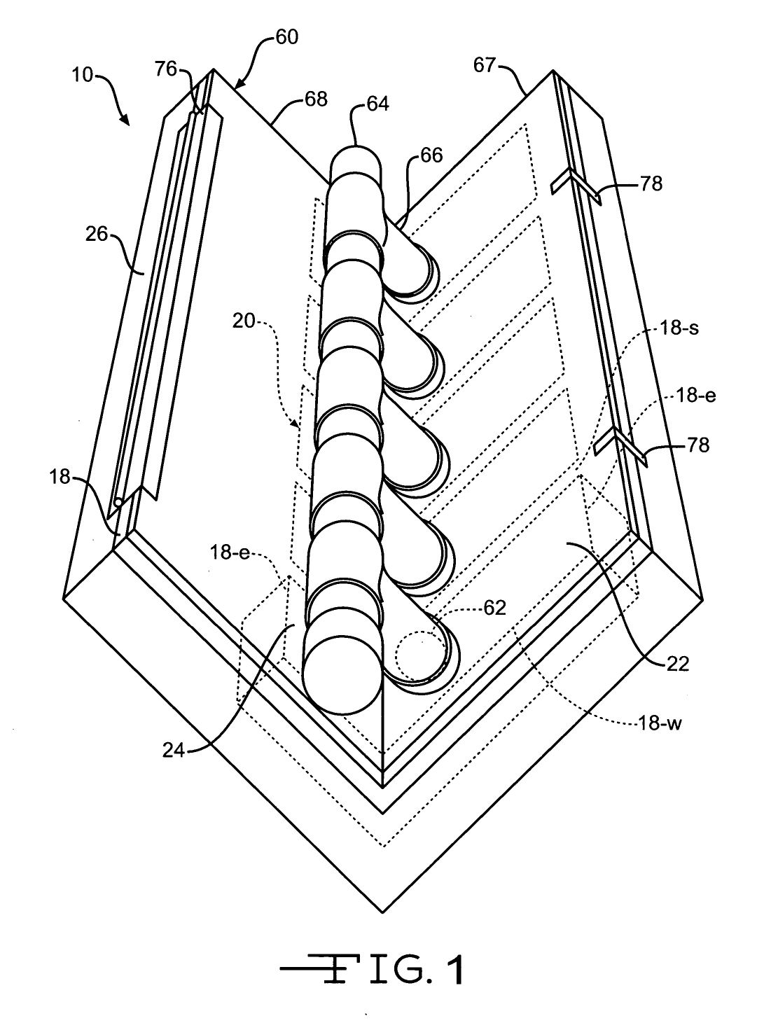

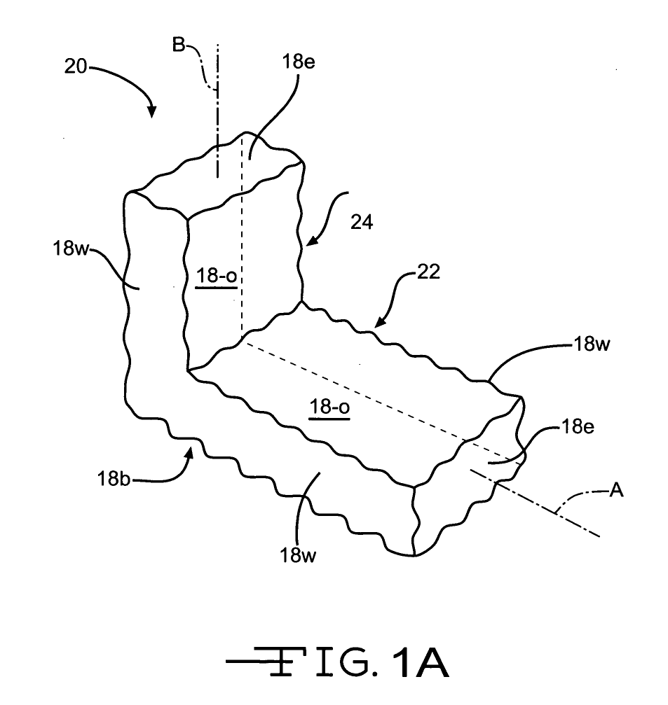

The simulated corner stone products can be in the form of corner pieces, corner hearth pieces and corner architectural trim products as well as other corner-shaped products. In one embodiment, illustrated in FIG. 1, a mold 10 includes at least one flexible layer 18 having one or more mold cavities 20. The flexible layer 18 can be made from one or more layers of a suitable flexible material. In one embodiment, the flexible layer 18 includes a curable elastomeric or rubber material such as latex or silicone rubber.

As shown in FIG. 1A, each mold cavity 20 has a corner shape. The mold cavity 20 has a first section 22 having a first longitudinal axis A that is in communication with a second section 24 having a second longitudinal axis B. In the embodiment shown, the first and second sections 22 and 24 are at substantially a right angle and have different lengths. In other embodiments, the first and second sections 22 and 24 have substantially the same length. In certain embodiments, where the first and second sections 22 and 24 have different lengths, the first section 22 can be about two to four or more times longer than the second section 24. Also, in certain embodiments, the first and second sections 22 and 24 can be positioned at an angle other than a right angle with respect to each other. In certain embodiments, the mold 10 can be oriented such that the first and second sections 22 and 23 are at an angle with respect to a horizontal surface to aid in the filling of the mold cavity 20.

Each of the first and second mold cavity sections 22 and 24 has an end wall 18-e and opposing sidewalls 18-w. The sidewalls 18-w and the end walls 18-e form the outer perimeters of the first and second sections 22 and 24. The mold cavity sections 22 and 24 each have a bottom 18-b and an opposing, top opening 18-o. The mold cavity sidewalls 18-w, the end walls 18-e, and the bottom 18-b have a stone textured surface.

In certain embodiments, as shown in FIG. 1, the flexible layer 18 also has support sections 18-s which are defined by the areas surrounding the mold cavity sidewalls 18-w and the mold cavities 20. The support sections 18-s divide the mold 10 into the individual mold cavities 20. In certain embodiments, the support sections 18-s have a flexural modulus that is stiffer or more rigid than the flexural modulus of the mold cavity bottom 18-b, the end walls 18-e, and the mold cavity sidewalls 18-w.

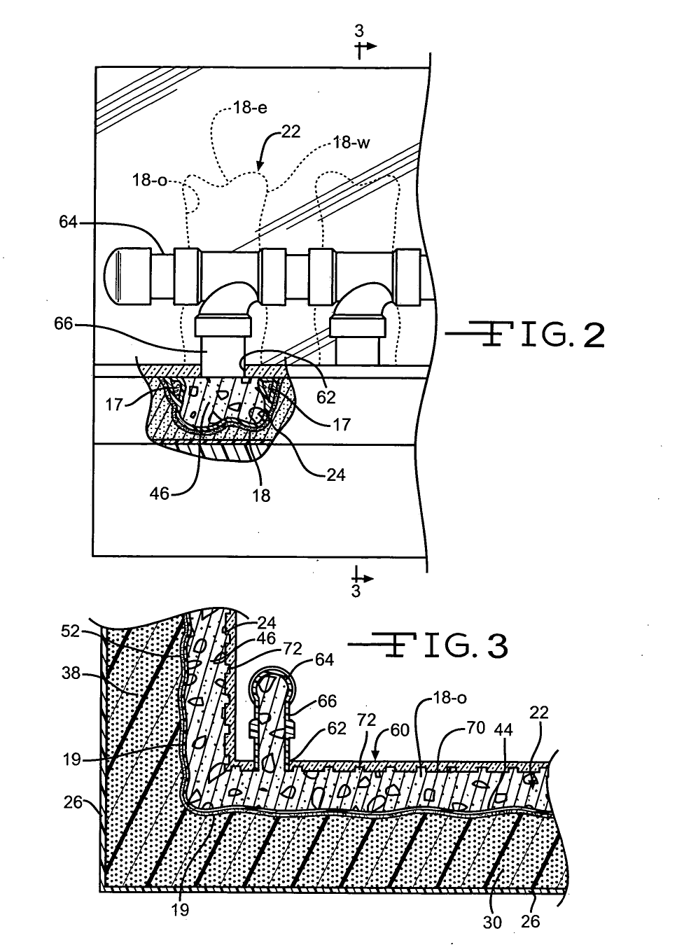

Also, in certain embodiments, as shown in FIG. 2, the flexible layer 18 can include a reinforcing material 17 which is added to, or encapsulated within, the sidewalls 18-w. The reinforcing material 17 reinforces the sidewalls 18-w, yet allows the sidewalls 18-w to still retain the desired flexibility. In certain embodiments, the reinforcing material 17 can comprise a paste-like material, comprising, for example, a latex material, ground up rubber tire, sawdust, and MgO composition.

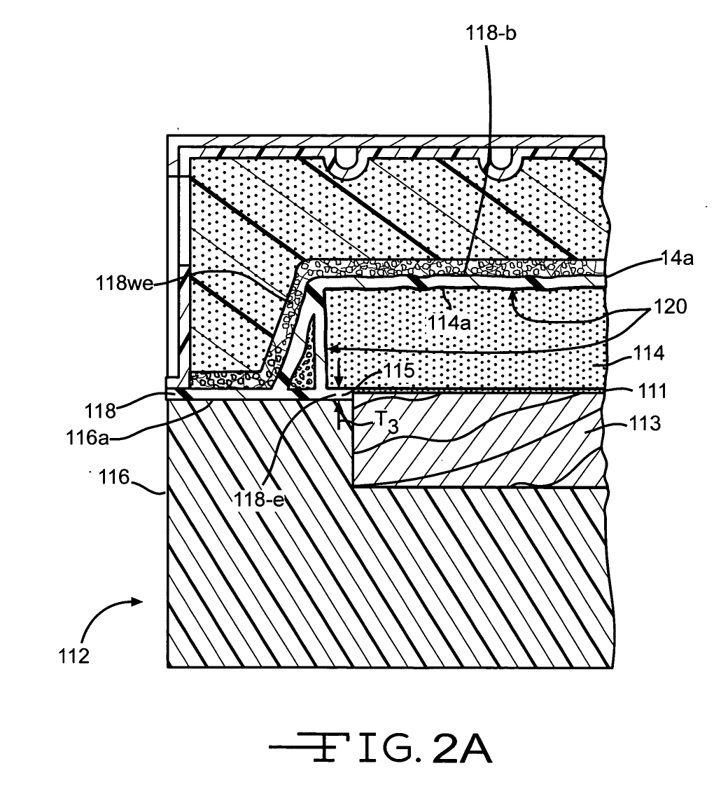

In certain embodiments, as shown in FIG. 3, a mold support 26 is used to hold the flexible layer 18. The mold support 26 can include a backing layer 19. In certain embodiments, the backing layer 19 comprises a porous material such as, for example, a breathable mesh material or a polyurethane-fiberglass applied non-woven mat material.

A structural material 38 is positioned between the mold support 26 and the backing layer 19. The structural material 38, when hardened, provides support to the flexible layer 18, as described below. The structural material 38 can be introduced by any suitable means. It is desired that the structural material 38 be a load supporting material capable of providing structural strength. Some examples of suitable type of structural material include foams such as polyurethane, polystyrene and polyphenylene oxide; however, many other types of structural materials can be used.

In certain embodiments, each mold cavity 20 is painted with a layer 44 of one or more suitable stone-colored paints. In certain embodiments, especially where the flexible layer 18 has deep and/or narrow sidewalls 18-w and end walls 18-e, the painting of such vertical surfaces can be done by inflating the flexible layer 18 to open up the mold cavity 20 and allow easier painting of the end walls 18-e, the sidewalls 18-w and the bottom 18-b.

After the mold 10 has been set in position (and, in certain embodiments, painted), a castable material 46 is introduced into each mold cavity 20.

It is to be understood that any suitable castable material 46 can be used for producing the simulated corner stone products. In one embodiment, the castable material 46 is a lightweight concrete material comprising Portland cement, lightweight aggregates and mineral oxides. In certain embodiments, especially suitable simulated corner stone castable materials can include those made by Owens Corning: Cultured Cornerstone® Textures, such as: Southern Ledgestone, Country Ledgestone, Drystack Ledgestone; Limestone, Weather Edge Ledgestone, Pro-fit Ledgestone, Carolina Ledgestone and Cobblefield® stone. However, other castable materials are also useful, such as plaster of Paris, a resin material, or a ceramic material.

The mold 10 includes a removable cover 60. The cover 60 substantially encloses each opening 18-o of the first and second mold sections 22 and 24. The cover 60 includes a plurality of apertures 62 so that an aperture 62 is adjacent to a corresponding top opening 18-o. The aperture 62 is smaller than the opening 18-o of the mold cavity 20.

FIG. 1 shows a main supply manifold 64 having a plurality of delivery conduits 66. The supply manifold 64 is positioned adjacent to, an in communication with, the cover 60 to deliver a supply of castable material 46 to each mold cavity 20. Each delivery conduit 66 is in communication with the corresponding aperture 62 in the cover 60. In certain embodiments, the delivery conduits 66 have an arcuate shape to aid in the flow of the castable material 46 from the main supply manifold 64, through the delivery conduit 66 and through the aperture 62 into each mold cavity 20. The castable material 46 is delivered at a suitable pressure, speed and volume such that the castable material 46 substantially fills both the first section 22 and the second section 24 of each mold cavity 20.

The cover 60 includes a first lid section 67, as best seen in FIG. 1, which is positioned at a desired angle to a second lid section 68. The first and second lid sections 67 and 68 can be formed as a unitary piece. In other embodiments, the first and second lid sections 67 and 68 can be formed as separate pieces and the secured together to form the desired angle.

The angle defined by the first and second lid sections 67 and 68 is the same angle as the angle defined by the first and second sections 22 and 24 of the mold cavity 20. The first and second lid sections 67 and 68 provide the cover 60 with a secure fit over the top openings 18-o.

The cover 60 has an inner face 70 that is in contact with each mold cavity 20. In certain embodiments, the inner face 70 can have a textured, or roughened, surface 72 that is at least adjacent to each mold cavity 20. In certain embodiments, the roughened surface 72 can be deep lines or cross hatch lines that would aid in the gripping strength of the mortar during the installation of the simulated stone product.

The cover 60 can be attached to the mold support 26 with a suitable attachment member 76, such as a hinge. Also, the cover 60 can be secured to the mold support 26 with a suitable securing member 78, such as a latch.

In certain embodiments, the mold 10 may be vibrated after the castable material 46 fills each mold cavity 20 to insure that the castable material 46 flows into all the contours of each mold cavity 20 and/or a vacuum may be pulled to assist flow of the material (not shown).

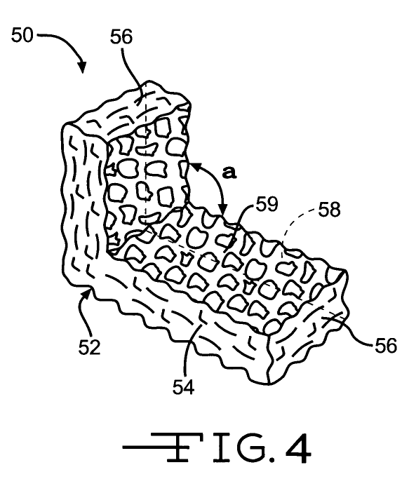

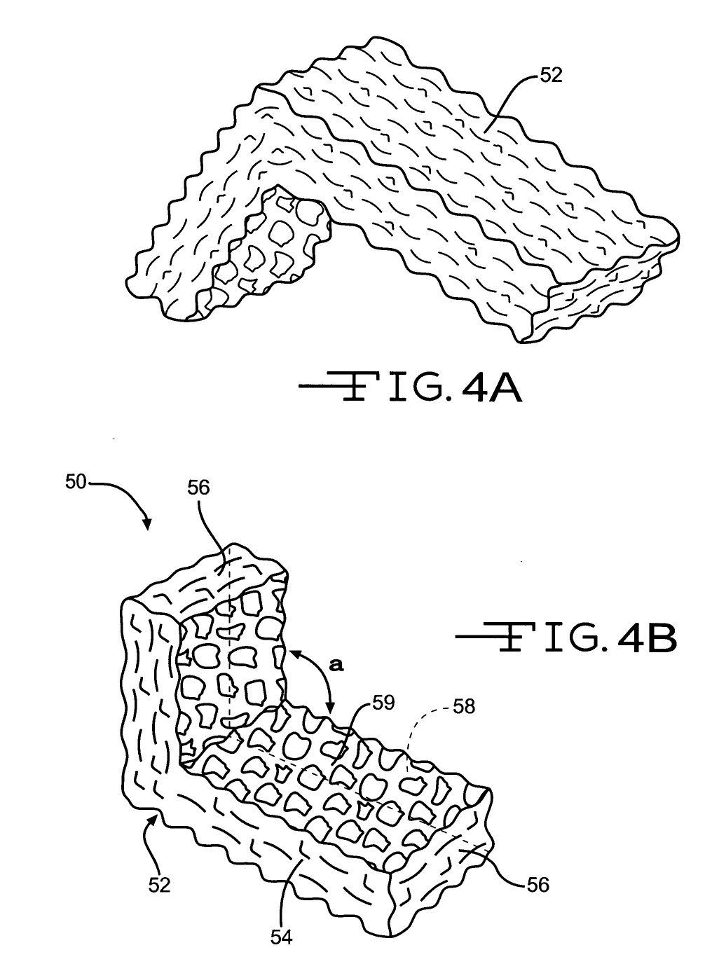

Upon hardening, the castable material 46 in each mold cavity 20 becomes a corner stone product 50, which is schematically illustrated in FIGS. 4A and 4B. After hardening, the corner stone product 50 is then removed from the mold cavity 20 in a suitable manner. FIG. 4B is a schematic perspective view, partially in phantom, of the corner simulated stone product 50, as viewed from the back face 59. FIG. 4A is a schematic perspective view, partially in phantom, of the corner simulated stone product 50, as viewed from the front face 52.

In certain embodiments, the corner stone product 50 is at least partially dislodged from the mold cavity 20 by flexing the flexible layer 18 to force the corner stone product 50 from its mold cavity 20. In certain embodiments, a pressurized fluid, such as air, is introduced between the flexible layer 18 and the mold support 26. In the embodiments where the flexible layer 18 includes support sections 18-s, the support sections 18-s are at least partially restrained from being stretched or distorted by the pressurized fluid. The mold cavity bottoms 18-b, the end walls 18-e and sidewalls 18-w are stretched or flexed, thereby at least partially lifting the corner stone product 50 from the mold cavity 20. In embodiments where the porous backing layer 19 is present, the fluid passes through the porous backing layer 19 and contacts the flexible layer 18.

Referring now again to FIGS. 4A and 4B, the simulated corner stone product 50 has a simulated stone textured front face 52, a simulated stone textured first side face 54, opposing simulated stone textured end faces 56, and a simulated stone textured second side face 58. The simulated corner stone product 50 also has a back face 59 which has an exposed, aggregate-filled, untextured surface. The untextured back face 59 has a desirable molded interior corner angle, shown in FIG. 4B as “a”.

The textured front face 52 of the corner stone product 50 is formed by the textured bottom 18-b of the mold cavity 20. The textured end faces 56 of the corner stone product 50 are formed by the textured end walls 1-8e of the mold cavity 20. The first and second textured side faces 54 and 58 are formed by the textured sidewalls 18-w of the mold cavity 20. Thus, when the corner stone product 50 is installed, the simulated stone textured faces 52, 54, 56 and 58 present an aesthetically pleasing appearance

During the casting of the corner stone product 50, the cover 60 provides the untextured back face 59 of the corner stone product 50 with a desirable molded interior angle. The untextured back face 59 of the corner stone product 50 has a relatively exact interior angle which does not require any extra labor to screed (i.e., either clean or remove) any unwanted molded castable material from the interior angle. The molded interior angle eliminates the extra processing steps that had previously been needed in other castable corner stones where the interior angle had to be cleaned and/or straightened before the castable material was allowed to cure.

In the past, the castable material was manually removed from the stone products by workers who had to strikeoff, or screed, the castable material before the castable material set or cured. By eliminating the need for workers to perform extensive screeding operations to form corner stones, the present invention provides a safer and more efficient process.

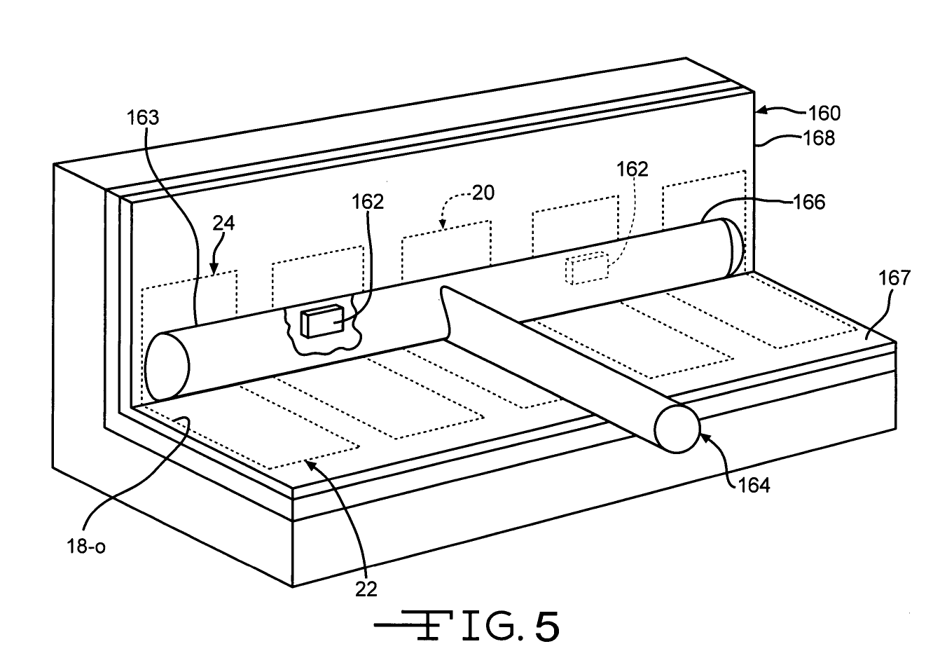

FIG. 5 illustrates another embodiment of a removable cover 160. It is to be noted that where features are the same as for the other embodiments described herein, such features are not further described herein in detail. The cover 160 substantially encloses each opening 18-o of the first and second mold sections 22 and 24. The cover 160 includes a plurality of apertures 162 so that an aperture 162 is adjacent to a corresponding opening 18-o. Each aperture 162 is smaller than the opening 18-o of the mold cavity 20.

A main supply manifold 164 having a delivery conduit 166 is positioned adjacent to the cover 160 to deliver the castable material. The delivery conduit 166 is in communication with the corresponding apertures 162 in the cover 160. In certain embodiments, the delivery conduit 166 has a semi-circular cross-sectional shape 163 to aid in the flow of the castable material 46, through the aperture 162 into each mold cavity 20.

The cover 160 includes a first lid section 167 which is positioned at an angle with respect to a second lid section 168. The angle defined by the first and second lid sections 167 and 168 is substantially the same angle as the angle defined by the first and second sections 22 and 24 of the mold cavity 20. The first and second lid sections 167 and 168 provide the cover 160 with a secure fit over the openings 18-o.

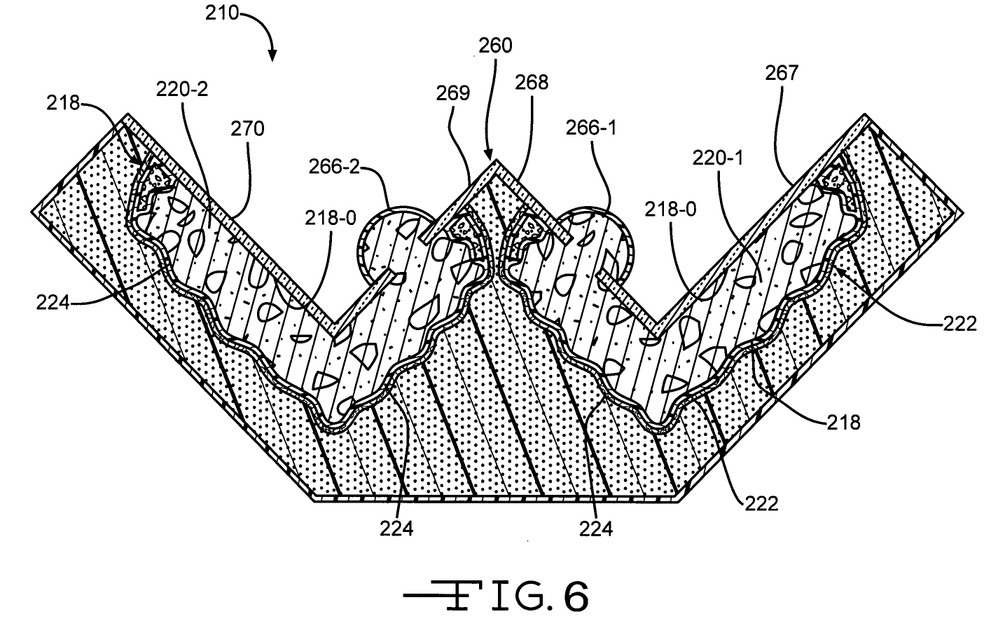

FIG. 6 illustrates a cross-sectional view of another embodiment of a mold 210 having a cover 260. It is to be noted that where features are the same as for the other embodiments described herein, such features are not further described herein in detail. It is to be understood that the mold 210 can have a plurality, or sets, of mold cavities, shown in FIG. 6 as 220-1 and 220-2, where each mold cavity 220-1 and 220-1 is substantially similar to those shown in the other embodiments. The mold 210 has a flexible layer 218 with forms each the first mold cavity 220-1 and the second, and opposing, mold cavity 220-2. For ease of discussion, when each mold cavity 220-1 and 220-2 has the same features or the same positional relationship to other features described herein, only one mold cavity will be discussed in detail. As such, each mold cavity 220-1 and 220-2 is shown as having a first section 222 and a second section 224.

In the embodiment shown in FIG. 6, the first mold cavity 220-1 is oriented at an acute angle to the second mold cavity 220-2. In certain embodiments, the second sections 224 of each of the first and second mold cavities 220-1 and 220-2 are in a substantially perpendicular orientation with respect to each other. In certain other embodiments, the first and second mold cavities 220-1 and 220-2 can be positioned at an angle other than a right angle with respect to each other.

The cover 260 includes a first lid section 267 which is positioned at an acute angle to a second lid section 268. A third lid section 269 is positioned at an acute angle to the second lid section 268. A fourth lid section 270 is positioned at an acute angle to the third lid section 269. The cover 260 thus has a general “W” shape.

The angle defined by the first and second lid sections 267 and 268 is substantially the same angle as the angle defined by the first and second sections 222 and 224 of the first mold cavity 220-1. The first and second lid sections 267 and 268 substantially enclose the top openings 218-o of the first mold cavity 220-1. The first and second lid sections 267 and 268 can be formed as a unitary piece. In other embodiments, the first and second lid sections 267 and 268 can be formed as separate pieces and the secured together to form the desired angle.

Likewise, the angle defined by the third and fourth lid sections 269 and 270 is the same angle as the angle defined by the first and second sections 222 and 224 of the second mold cavity 220-2. The third and fourth lid sections 269 and 270 substantially enclose the top openings 218-o of the second mold cavity 220-2. The third and fourth lid sections 269 and 270 can be formed as a unitary piece. In other embodiments, the first and second lid sections 269 and 270 can be formed as separate pieces and the secured together to form the desired angle.

The second lid section 268 and the third lid section 269 each include a plurality of apertures 262 so that an aperture 262 is adjacent to a corresponding top opening 218-o. The aperture 262 is smaller than the opening 218-o of the mold cavity 220.

In the embodiment shown in FIG. 6, the mold cavities 220-1 and 220-2 are supplied with a castable material by separate delivery conduits, 266-1 and 266-2, respectively. The delivery conduits 266-1 and 266-2 can be substantially similar to the delivery conduit 166 shown in FIG. 5.

While the invention has been described with reference to a preferred embodiment, it should be understood by those skilled in the art that various changes may be made and equivalents may be substituted for elements thereof without departing from the essential scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims.

What is claimed is:

1. A mold for manufacturing one or more shaped simulated stone products, the mold comprising:
i) a flexible layer having one or more corner-shaped mold cavities, each mold cavity having a top opening, opposing sidewalls, opposing end walls, and a bottom;
each of the top opening, opposing sidewalls, opposing end walls, and bottom being configured to imprint a texture on side faces, end faces and a front face of each shaped product; and,
ii) a cover configured to enclose the top opening of each mold cavity and configured to provide each shaped product with a back face having a desirable bottom surface.

2. The mold of claim 1, wherein the stone products comprise corner-shaped simulated stone products, the mold further comprising:
the a cover being configured provide each corner-shaped product with a back face having a desirable molded interior angle.

3. The mold of claim 2, wherein each mold cavity has a first mold section in communication with a second mold section; the first mold section being oriented at the desired interior angle with respect to the second mold section.

4. The mold of claim 3, wherein the first and second mold sections are oriented at a substantially 90° angle to each other.

5. The mold of claim 3, including a supply manifold in communication with the cover and configured to deliver a supply of a castable material to each mold cavity.

6. The mold of claim 5, wherein the supply manifold includes a plurality of apertures; each aperture positioned in communication with a corresponding top opening in each mold cavity.

7. The mold of claim 6, wherein the supply manifold includes a plurality of delivery conduits; each delivery conduit being in communication with the corresponding top opening in each mold cavity, wherein each delivery conduit has an arcuate shape configured to aid flow of the castable material from the supply manifold into each mold cavity.

8. The mold of claim 2, wherein the cover includes a first lid section and a second lid section, the first and second lid sections being oriented at substantially the same interior angle as the back face of each corner-shaped product.

9. The mold of claim 2, wherein the cover has an inner face defining a textured surface adjacent to each mold cavity.

10. A mold for manufacturing one or more corner-shaped simulated stone products, the mold comprising:
i) a flexible layer having:
a first set of corner-shaped mold cavities oriented at an acute angle with respect to a second set of corner-shaped mold cavities; each mold cavity in each set having a top opening, opposing sidewalls, opposing end walls, and a bottom;
each of the top opening, opposing sidewalls, opposing end walls, and bottom being configured to imprint a texture on side faces, end faces, and a front face of each corner-shaped product; and,
ii) a cover configured to substantially enclose the top opening of each mold cavity and configured to provide each corner-shaped product with a back face having a desirable molded interior angle;
the cover including a first lid section which is positioned at an acute angle to a second lid section, the first and second lid sections being configured to enclose each top opening of the mold cavities of the first set;
the cover including a third lid section which is positioned at an acute angle to the second lid section; and, a fourth lid section which is positioned at an acute angle to the third lid section, the third and fourth lid sections being configured to enclose each top opening of the mold cavities of the second set.

11. The mold of claim 10, wherein each mold cavity has a first mold section in communication with a second mold section; the first mold section being oriented at the desired interior angle with respect to the second mold section; and, wherein the second mold sections in the first set are positioned at an angle to the second mold sections in the second set.

12. The mold of claim 11, wherein the second mold sections of the first set of mold cavities and the second set of mold cavities are oriented at a substantially 90° angle to each other.

13. The mold of claim 10, including a supply manifold in communication with the cover and configured to deliver a supply of a castable material to each mold cavity.

14. The mold of claim 13, wherein the supply manifold includes a plurality of apertures; each aperture positioned in communication with the corresponding top opening in each mold cavity.

15. The mold of claim 11, wherein the cover has an inner face defining a textured surface adjacent to each mold cavity.

16. A method of manufacturing one or more corner-shaped simulated stone products, the method comprising:
a) supplying a mold having a flexible layer; the flexible layer having:
i) one or more mold cavities; each mold cavity having a top opening, opposing sidewalls, opposing end walls, and a bottom;
each of the top opening, opposing sidewalls, opposing end walls, and bottom being configured to imprint a texture on side faces, end faces, and a front face of each corner stone product; and,
ii) a cover configured to substantially enclose the top opening of each mold cavity and to provide each corner-shaped product with a back face having a desirable molded interior angle;
b) moving the cover to a closed position against the top opening of each mold cavity;
c) introducing a castable material into each mold cavity;
e) allowing the castable material to harden to form each corner-shaped product; and,
f) removing each corner-shaped product from its mold cavity.

17. The method of claim 16, wherein the flexible layer further includes one or more support sections at least partially surrounding the flexible layer; the method further including: substantially restraining the support section prior supplying pressure to each mold cavity sufficient to cause each mold cavity to be flexed, thereby at least partially dislodging each corner-shaped product from its mold cavity.

18. The method of claim 16, including delivering the castable material using a supply manifold having a plurality of apertures; each aperture being positioned in communication with the corresponding top opening for each mold cavity.

19. The method of claim 16, further including providing the cover with a first lid section and a second lid section, the first and second lid sections being oriented at substantially the same interior angle as the back face of the corner-shaped product.

20. The method of claim 16, further including:
providing the mold having at least a first set of mold cavities and a second set of mold cavities, each set of mold cavities being disposed at an acute angle with respect to the other; each mold cavity in each set having a first mold section in communication with a second mold section; the first mold section being oriented at the desired interior angle with respect to the second mold section, wherein the second mold sections in the first set are positioned at an angle to the second mold sections in the second set; and,
providing the cover with a first lid section which is positioned at an angle to a second lid section, wherein the first and second lid section enclose the top openings of the mold cavities of the first set; a third lid section which is positioned at an angle to the second lid section; and, a fourth lid section which is positioned at an angle to the third lid section, wherein the third and fourth lid section enclose the top openings of the mold cavities of the second set.

21. The method of claim 20, wherein each of the first, second, third and fourth lid sections are oriented at a substantially 90° angle to each other.

22. A simulated stone product having a corner shape made using the mold of claim 2.

23. A simulated stone product having a corner shape made using the mold of claim 10.

24. A simulated stone product having a corner shape made using the method of claim 16.
